(19) United States
(12) Patent Application Publication
(10) Pub. No.: US 2011/0195347 A1
(43) Pub. Date: Aug. 11, 2011

(54) PROCESS FOR PRODUCING A CATALYST AND CATALYST

(75) Inventors: Claudia Querner, Ludwigshafen (DE); Ekkehard Schwab, Neustadt (DE); Bastian Ewald, Ludwigshafen (DE)

(73) Assignee: BASF SE, Ludwigshafen (DE)

(21) Appl. No.: 13/021,242

(22) Filed: Feb. 4, 2011

Related U.S. Application Data
(60) Provisional application No. 61/301,642, filed on Feb. 5, 2010.

(51) Int. Cl. H01M 4/96; B01J 27/22

(52) U.S. Cl. 429/528; 502/177

(57) ABSTRACT

The invention relates to a process for producing a catalyst, where the catalyst comprises a catalytically active material and a carbon-comprising support, in which the carbon-comprising support is impregnated with a metal salt solution in a first step, the carbon-comprising support impregnated with the metal salt solution is subsequently heated to a temperature of at least 1500° C. in an inert atmosphere to form a metal carbide layer and the catalytically active material is finally applied to the carbon-comprising support provided with the metal carbide layer. The invention further provides a catalyst which has been produced by the process and comprises a carbon-comprising support and a catalytically active material, with the carbon-comprising support having a metal carbide layer and the catalytically active material having been applied to the carbon-comprising support provided with the metal carbide layer.

The invention relates to a process for producing a catalyst, where the catalyst comprises a catalytically active material and a modified carbon-comprising support. The invention further relates to a catalyst comprising a modified carbon-comprising support and a catalytically active material.

Catalysts comprising a catalytically active material and a carbon-comprising support are used, for example, as heterogeneous catalysts for electrochemical reactions. As catalytically active material for electrochemical reactions, use is usually made of metals of the platinum group or alloys of the metals of the platinum group. Alloying components used are generally transition metals, for example nickel, cobalt, vanadium, iron, titanium, copper, ruthenium, palladium, etc., in each case individually or in combination with one or more further metals. Such catalysts are used, in particular, in fuel cells. The catalysts can be used both on the anode side and on the cathode side. Particularly on the cathode side, it is necessary to use active cathode catalysts which are also corrosion-stable. Alloy catalysts are generally used as active cathode catalysts.

To obtain a high catalytic surface area, the catalysts are usually supported. For electrochemical applications, the support used has to be electrically conductive. Carbon, for example in the form of conductive carbon blacks, is generally used as support. Carbon supports used usually have a high specific surface area which allows fine dispersion of the particles of the catalytically active material, which are usually present as nanoparticles. The BET surface area is generally above 100 m²/g. However, these carbon supports, for example Vulcan XC72 having a BET surface area of about 250 m²/g or Ketjen Black EC-300J having a BET surface area of about 850 m²/g, have the disadvantage that they corrode very rapidly. The corrosion of carbon-comprising supports can be compared, for example, by subjecting them to potentials above 1 V in the presence of water, for example in a humid stream of nitrogen or in an aqueous electrolyte solution, if appropriate at elevated temperature. Here, the carbon is converted into carbon dioxide and the carbon dioxide formed can be measured. The higher the temperature and the higher the potential, the more rapidly does the carbon-comprising support corrode. Thus, for example, in the case of Vulcan XC72 at potentials of 1.1 V, about 60% of the carbon is corroded away by oxidation to carbon dioxide after 15 hours. In the case of carbon blacks having a smaller specific surface area, for example DenkaBlack having a BET surface area of about 60 m²/g, the corrosion stability of the support is higher since the proportion of graphite in the carbon black is higher. The corrosion corresponds to a loss of carbon of only 8% after 15 hours at 1.1 V. The catalyst particles on carbon supports having a lower surface area are usually somewhat larger and are therefore closer to one another. However, this frequently leads to a decrease in performance since only a small part of the amount of catalytically active material applied to the support can be utilized catalytically.

Apart from the use of a carbon support having a lower BET surface area, subjecting the carbon-comprising support to a surface treatment is also known, for example from WO 2006/002228. As a result of the surface treatment, the carbon is provided with a metal carbide layer. Metals used for producing the metal carbide layer are, for example, titanium, tungsten or molybdenum. The catalytically active material is subsequently deposited on the metal carbide layer.

To produce the metal carbide layer, a metal salt solution is firstly applied to the surface of the carbon-comprising support and this solution is then reduced to the metal. The support is subsequently heated to convert the metal into metal carbide. Heating to form the metal carbide layer is carried out at a temperature in the range from 850 to 1100° C. However, it has been found that the carbide layer produced as described in WO-A 2006/002228 is not sufficiently stable to bring about a satisfactory improvement in the corrosion stability.

The corrosion of the carbon-comprising support leads to detachment of the particles of the catalytically active material and thus to a decrease in performance. In addition, the catalyst particles can also sinter, which significantly reduces the catalytically active surface area.

It is an object of the present invention to provide a process for producing a catalyst, in which a catalyst which is corrosion-stable when used as cathode catalyst for electrochemical reactions is produced. In particular, a catalyst whose catalyst particles interact with the surface area in such a way that the particles change only little on the support, i.e. barely sinter and do not become detached from the support, should be provided.

The object is achieved by a process for producing a catalyst, where the catalyst comprises a catalytically active material and a carbon-comprising support, which comprises the following steps:
(a) impregnation of the carbon-comprising support with a metal salt solution,
(b) heating of the carbon-comprising support impregnated with the metal salt solution to a temperature of at least 1200° C. to form a metal carbide layer,
(c) application of the catalytically active material to the carbon-comprising support provided with the metal carbide layer.

As a result of the heating of the carbon-comprising support impregnated with the metal salt solution to a temperature of at least 1200° C., a stable metal carbide layer is formed. Due to the metal carbide layer on the support, the carbon is bound on the surface and no longer undergoes any reaction with the oxygen surrounding the support. The corrosion of the carbon-comprising support can in this way be reduced or even be avoided completely. A further advantage is that the catalytically active surface of the catalyst is not changed significantly by formation of the metal carbide layer and a constantly high catalytic activity and long-term stability are thus achieved. In addition, the loss of catalytically active material can be prevented by the metal carbide layer, so that the catalytic activity of the catalyst is not reduced by lost catalytically active material. The fact that the catalytically active material is not detached from the support is associated with the particles of the catalytically active material adhering better to the support as a result of the metal carbide layer. Due to the fact that the catalyst particles sinter very little and do not become detached from the support, the catalytic surface area of the catalyst particles remains stable over a long period of time and the performance of the electrode remains high. In addition, no oxidic phases but only carbide phases can be observed in the X-ray diffraction pattern.

The improved adhesion of the catalytically active material can be examined, for example, by means of transmission electron microscopy. Thus, according to Journal of Power Sources, 2008, 185, pages 734-739, it is possible to produce an image of an electrocatalyst at the same place before and after electrochemical treatment and observe the changes in the catalyst caused thereby. In this way, it is possible, for example, to see the sintering or detachment of the particles of catalytically active material in the case of pure carbon-supported catalysts, while barely any changes occur under the same conditions in the case of the catalysts according to the invention.

Suitable carbon-comprising supports for the catalyst of the invention are preferably carbon blacks. The carbon black can be produced by any process known to those skilled in the art. Carbon blacks which are usually used are, for example, furnace black, flame black, acetylene black or any other carbon black known to those skilled in the art. The use of graphitized carbon, in particular carbon having a low surface area, is particularly preferred. For the purposes of the present invention, low surface area means a BET surface area of not more than 250 m²/g, more preferably not more than 100 m²/g. Suitable carbons which can be used as support are, for example, SKW Carbon having a BET surface area of 72 m²/g, DenkaBlack having a BET surface area of 53 m²/g or XMB206 or AT325 from Evonik Degussa GmbH, having a BET surface area of about 30 m²/g. According to the invention, a metal carbide layer is applied to the appropriate carbon support.

The catalytically active material used comprises, for example, a metal of the platinum group, a transition metal, an alloy of these metals or an alloy comprising at least one metal of the platinum group. The catalytically active material is preferably selected from among platinum and palladium and alloys of these metals and alloys comprising at least one of these metals. The catalytically active material is very particularly preferably platinum or a platinum-comprising alloy. Suitable alloying metals are, for example, nickel, cobalt, iron, vanadium, titanium, ruthenium and copper, in particular nickel and cobalt. Suitable alloys comprising at least one metal of the platinum group are, for example, selected from the group consisting of PtNi, PtFe, PtV, PtCr, PtTi, PtCu, PtPd, PtRu, PdNi, PdFe, PdCr, PdTi, PdCu and PdRu. Particular preference is given to a platinum-nickel alloy or a platinum-cobalt alloy. When an alloy is used as catalytically active material, the proportion of metal of the platinum group in the alloy is preferably in the range from 25 to 85 atom % and more preferably in the range from 40 to 80 atom %, even more preferably in the range from 50 to 80 atom % and in particular in the range from 60 to 80 atom %.

Apart from the alloys mentioned, it is also possible to use alloys comprising more than two different metals, for example ternary alloy systems. It is also possible for further components to be comprised, usually in a proportion of less than 1% by weight, for example metal oxides.

To produce the catalyst of the invention, the carbon-comprising support is impregnated with a metal salt solution in a first step. To impregnate the carbon-comprising support with the metal salt solution, it is possible, for example, to disperse the carbon-comprising support in the metal salt solution and subsequently concentrate the dispersion.

As a result of the impregnation, the metal salt solution penetrates into the pores of the carbon-comprising support. A metal salt layer is also formed on the outer surface of the carbon-comprising support.

Since complete conversion of the carbon into a metal carbide entails the risk that the advantageous base structure of the carbon used, for example carbon black, is lost to such an extent that the performance of the catalysts produced therefrom or the processability of the catalysts is influenced too greatly, the surface is preferably converted into a metal carbide.

To prevent the total carbon of the support from reacting to form a metal carbide and a metal carbide layer from being formed only on the surface of the support, the metal salt solution for impregnating the carbon-comprising support is preferably added in a substoichiometric amount. For the purposes of the present invention, substoichiometric means that less than 90% by weight of metal based on the sum of metal and carbon is used. The proportion of metal is usually from 5 to 75% by weight, preferably from 20 to 50% by weight, in each case based on the sum of metal and carbon.

To obtain a stable metal carbide layer on the carbon-comprising support, the metal of the metal salt solution is tungsten, molybdenum, titanium, vanadium or zirconium, preferably tungsten or molybdenum. As a result of the use of the corresponding metal salt solution, the metal carbide layer formed on the carbon-comprising support is a tungsten carbide layer or molybdenum carbide layer. Furthermore, the layer can also comprise mixed carbides of two or more metals. It is also possible for the metal carbide layer to be doped with a second metal. An advantage of the metal carbide layer is that the advantageous structural, conductivity and surface properties of the carbon-comprising support are substantially retained and the corrosion resistance is significantly improved. The retention of the properties of the carbon-comprising support is dependent on the carbide content on the surface of the support.

As metal salt solution with which the carbon-comprising support is impregnated, it is possible to use, for example, a tungstate solution, for example an ammonium tungstate solution.

To produce the metal carbide layer, the carbon-comprising support impregnated with the metal salt solution is, in a second step, heated to a temperature of at least 1200° C. in an inert atmosphere. Inert atmosphere means that the atmosphere does not comprise any materials which can react with the carbon of the support or the metal salt. A suitable atmosphere is, for example, a noble gas atmosphere or a nitrogen atmosphere. The inert atmosphere is preferably a nitrogen atmosphere.

The temperature to which the carbon-comprising support impregnated with the metal salt solution is heated is at least 1200° C., preferably at least 1300° C. and in particular at least 1500° C.

To form a sufficiently stable metal carbide layer on the carbon-comprising support, the carbon-comprising support impregnated with the metal salt solution is maintained for at least 30 minutes, preferably at least one hour, in particular at least 2 hours, at the temperature to which the carbon-comprising support impregnated with the metal salt solution has been heated. Particular preference is given to the heat treatment being carried out at a temperature of 1500° C. for a period of 2 hours. This results in a metal carbide layer which significantly improves the corrosion stability of the carbon-comprising support being formed on the surface of the carbon-comprising support.

After formation of the metal carbide layer, the carbon-comprising support provided with the metal carbide layer is cooled and the catalytically active material is applied. Application of the catalytically active material can be effected by any method known to those skilled in the art. The application of the catalytically active material can, for example, be carried out by deposition in solution. For this purpose, it is possible, for example, to dissolve metal compounds comprising the catalytically active material in a solvent. The metal can be bound covalently, ionically or by complexation. Furthermore, it is also possible for the metal to be deposited reductively, as precursor or by means of alkali to precipitate the corresponding hydroxide. Further possible ways of depositing the metal of the platinum group are impregnation with a solution comprising the metal (incipient wetness), chemical vapor deposition (CVD) or physical vapor deposition (PVD) processes and also all further processes known to those skilled in the art by means of which a metal can be deposited. Preference is given to firstly precipitating a salt of the metal of the platinum group. Precipitation is followed by drying and heat treatment to produce the catalyst.

When the catalytically active material is applied by precipitation, it is possible to carry out, for example, a reductive precipitation, for example of platinum from platinum nitrate, in ethanol or by means of NaBH₄. As an alternative, decomposition and reduction in an H₂/N₂ gas mixture, for example of platinum acetylacetonate mixed with the carbon-comprising support provided with the metal carbide layer, is also possible. Preference is given to carrying out a reductive precipitation by means of ethanol.

When palladium or an alloy comprising a metal of the platinum group is used instead of platinum as catalytically active material, the catalytically active material is applied analogously.

A catalyst produced by the process of the invention comprises a carbon-comprising support and a catalytically active material, with the carbon-comprising support having a metal carbide layer and the catalytically active material having been applied to the carbon-comprising support provided with the metal carbide layer. As stated above, the corrosion of the carbon support and thus the detachment and loss of catalytically active material can be significantly reduced by the metal carbide layer.

The specific surface area and thus also the BET surface area of the carbon-comprising support provided with the metal carbide layer is dependent on the carbon-comprising support originally used. Preference is given to the carbon-comprising support having a BET surface area of not more than 250 m²/g. Particular preference is given to the carbon-comprising support having a BET surface area of not more than 100 m²/g.

To use the catalyst of the invention as, for example, heterogeneous catalyst for electrochemical reactions, preference is given to the catalytically active material being a metal of the platinum group or an alloy comprising at least one metal of the platinum group. Suitable metals of the platinum group are, in particular, platinum and palladium. It is also possible for platinum and palladium as a mixture to form the catalytically active material.

When the catalytically active material is an alloy comprising the at least one metal of the platinum group, this alloy is preferably selected from the group consisting of PtNi, PtFe, PtV, PtCr, PtTi, PtCu, PtPd, PtRu, PdNi, PdFe, PdCr, PdTi, PdCu and PdRu.

To achieve a reduction in corrosion, the metal of the metal carbide layer of the catalyst is preferably selected from the group consisting of tungsten, titanium, molybdenum, zirconium, niobium, vanadium and mixtures thereof. The metal of the metal carbide layer is particularly preferably tungsten.

The catalyst of the invention is particularly suitable for use as electrocatalyst in a fuel cell. Here, the catalyst is particularly suitable as cathode catalyst.

### EXAMPLES

A distinction is generally made between two phases in the corrosion of electrocatalysts: firstly, sintering of the catalytically active material, for example the platinum, and secondly carbon corrosion, with sintering of the catalytically active material occurring particularly at relatively low potentials and carbon corrosion occurring at higher potentials, for example above 1 V. Carbon corrosion is critical since a large amount of carbon can corrode away even in a short time at potential peaks of up to 1.5 V in operation of a fuel cell. As a result of carbon corrosion, there is firstly a change in the electrode structure which can lead to a decrease in performance and secondly the bonding to the particles of catalytically active material can also be lost, as a result of which the corresponding catalytically active particles are no longer available for the catalytic reaction and may even be discharged from the system, which can not only cause a decrease in performance but, particularly when noble metals are used, can be a large cost factor.

To make a preselection of corrosion-stable supports, accelerated aging tests can be carried out. It is thus possible, for example, to test the corrosion stability of the support in a fuel cell arrangement in which only the support instead of a catalyst is used on the cathode side and a humidified stream of nitrogen is introduced as carrier gas instead of the stream of air. A voltage of at least 1 V, for example 1.1 V or 1.2 V, is applied and the CO₂ formed by oxidation of the carbon support and carried out in the stream of gas is measured and converted into the loss of carbon of the support. The measurement is usually carried out at elevated temperature, for example 180° C., since, according to J. Power Sources, 2008, page 444, the corrosion rate is in this case about four orders of magnitude faster than at room temperature.

### Example 1

To modify the surface of DenkaBlack carbon black, 22 g of ammonium heptatungstate were dissolved in 580 g of H₂O and 15 g of DenkaBlack carbon black were added thereto. The mixture was homogenized by means of an Ultra-Turrax at 8000 rpm for 30 minutes. The carbon black suspension was concentrated on a rotary evaporator and heated in a tube furnace under nitrogen at 1500° C. for 6 h with an intermediate temperature stage at 400° C. for 1 h.

The tungsten loading was 47%. In the XRD, two tungsten carbide phases were observed: WC having a particle size of about 40 nm and W₂C having a particle size of about 23 nm. The surface-modified carbon support produced in this way will hereinafter be referred to as WC/Denka.

To produce the platinum catalyst, 7.0 g of the support produced in this way were dispersed in 500 ml of H₂O and homogenized by means of an Ultra-Turrax at 8000 rpm for 15 minutes. 5.13 g of platinum nitrate were dissolved in 100 ml of H₂O and slowly added to the support dispersion. 200 ml of H₂O and 800 ml of ethanol were subsequently added to the mixture and the mixture was refluxed for 6 h. After cooling overnight, the suspension was filtered, the solid was washed free of nitrate with 2 l of hot water and dried under reduced pressure. The platinum loading was 29.8% and the average crystallite size in the XRD was 3.4 nm.

### Example 2

To modify the surface of carbon black C2 (AT325 from Evonik Degussa GmbH), 5.9 g of ammonium heptatungstate were dissolved in 580 g of H₂O and 16 g of carbon black C2 were added thereto; the whole was homogenized by means of an Ultra-Turrax at 8000 rpm for 30 minutes. The carbon black suspension was concentrated on a rotary evaporator and heated in a tube furnace under nitrogen at 1500° C. for 6 h with an intermediate temperature stage at 400° C. for 1 h.

The tungsten loading was 16%. In the XRD, one tungsten carbide phase was observed: WC having a crystallite size of about 65 nm.

To produce a platinum catalyst, 10.5 g of the support produced in this way were dispersed in 500 ml of H₂O and homogenized by means of an Ultra-Turrax at 8000 rpm for 15 minutes. 7.77 g of platinum nitrate were dissolved in 100 ml of H₂O and slowly added to the support dispersion. 500 ml of H₂O and 450 ml of ethanol were subsequently added to the mixture and the mixture was refluxed for 6 h. After cooling overnight, the suspension was filtered, the solid was washed free of nitrate with 2 l of hot water and dried under reduced pressure. The platinum loading was 28.4% and the average crystallite size in the XRD was 3.1 nm.

### Comparative Example 1

7.0 g of carbon black C1 (XMB206 from Evonik Degussa GmbH) were dispersed in 500 ml of H₂O and homogenized by means of an Ultra-Turrax at 8000 rpm for 15 minutes. 5.13 g of platinum nitrate were dissolved in 100 ml of H₂O and slowly added to the carbon black dispersion. 200 ml of H₂O and 800 ml of ethanol were subsequently added to the mixture and the mixture was refluxed for 6 h. After cooling overnight, the suspension was filtered, the solid was washed free of nitrate with 2 l of hot water and dried under reduced pressure. The platinum loading was 27.1% and the average crystallite size in the XRD was 3.4 nm.

### Comparative Example 2

The preparation was carried out in a manner analogous to the method described in comparative example 1 with the exception of the carbon black support. Carbon black C2 was used instead of carbon black C1. The platinum loading was 27.4% and the average crystallite size in the XRD was 3.1 nm.

### Comparative Example 3

The modification of the surface was carried out in a manner analogous to the method described in example 2, but the carbidization step was carried out at a temperature of 850° C. for 6 h (analogous to WO 2006/002228) with an intermediate temperature stage at 400° C. for 1 h. The tungsten loading was 7%. The calculated value was 20%, i.e. the tungsten could not be deposited quantitatively. No tungsten carbide phase was observed in the XRD, only H₂WO₄*H₂O.

The platinum catalyst produced in this way (analogous to example 2) had a platinum loading of 28.9% and an average crystallite size of 3.4 nm.

### Comparative Example 3*

The preparation was carried out in a manner analogous to the method described in WO 2006/002228. For this purpose, 8 g of Vulcan XC72 were suspended in 1000 g of H₂O and homogenized by means of an Ultra-Turrax at 8000 rpm for 30 minutes. 3.2 g of ammonium tungstate were dissolved in 200 ml of H₂O and slowly added to the suspension. A further 750 ml of H₂O were added to the mixture and the mixture was refluxed for 4 h. 30.4 g of NaBH₄ were subsequently dissolved in 100 ml of water and added dropwise over a period of one hour with vigorous evolution of gas and the mixture was refluxed for a further 20 minutes. The reaction mixture was filtered and the solid was washed with 2 l of H₂O. The still moist filter cake was heated in a tube furnace, firstly at 100° C. for 1 h and subsequently at 900° C. for 1 h.

A platinum catalyst was produced on the support produced in this way. The platinum loading was 28.2% and the average crystallite size in the XRD was 2.0 nm. Only traces of tungsten could be detected (0.05%).

### Comparative Example 4

The preparation was carried out in a manner analogous to the method described in comparative example 1 with the exception of the carbon black support. A carbon black XC72 was used instead of the carbon black C1. The platinum loading was 27.7% and the average crystallite size in the XRD was 1.9 nm.

### Comparative Example 5

The preparation was carried out in a manner analogous to the method described in comparative example 1 with the exception of the carbon black support. DenkaBlack carbon black was used instead of the carbon black C1. The platinum loading was 27.7% and the average crystallite size in the XRD was 3.7 nm.

The loss in mass for four different carbon supports is shown in table 1.

TABLE 1
Loss in mass of the carbon supports

Loss in mass, % C

| Time at 1.2 V | C1 | C2 | WC/Denka | DenkaBlack |
|---|---|---|---|---|
| 1 h | 1 | 18 | 2 | 7 |
| 5 h | 6 | 26 | 8 | 33 |
| 15 h | 22 | 28 | 21 | 73 |

Carbon black C1 is XMB206 from Evonik Degussa GmbH, carbon black C2 is AT325 from Evonik Degussa GmbH and WC/Denka is a surface-modified carbon support produced as described in example 1.

It can be seen that the corrosion rate of the sample C1 and WC/Denka do not differ significantly. Observed differences between catalysts comprising the respective supports thus arise only from the interaction between catalyst particles and support.

The decrease in performance of electrocatalysts can also be estimated by means of accelerated aging tests. Thus, for example, the catalytic activity in respect of the reduction of oxygen (cathode reaction) can be determined before and after potential cycles. To determine the decrease in performance, 150 potential cycles between 0.5 and 1.3 V were carried out at a rate of 50 mV/s in the oxygen-saturated electrolyte. The results are shown in table 2. In table 2, WC/Denka is tungsten carbide on DenkaBlack carbon black, WC/C1 is tungsten carbide on carbon black C1 and WC/C2 is tungsten carbide on carbon black C2.

TABLE 2
Decrease in activity after 150 cycles

| | Sample, in each case | Decrease in activity |
|---|---|---|
| | 30% of Pt on | after 150 cycles (%) |
| Example 1 | 50% WC/Denka | −5% |
| Comparative example 1 | C1 | −32% |
| Comparative example 2 | C2 | −48% |
| Comparative example 3 | 20% WC/C2 (850° C.) | −48% |
| Comparative example 3* | 20% WC/C2 (900° C.) | −49% |
| (as per WO | | |
| 2006/002228) | | |
| Example 2 | 20% WC/C2 (1500° C.) | −22% |
| Comparative example 4 | Vulcan XC72 | −74% |
| Comparative example 5 | untreated DenkaBlack | −50% |

Comparison of the tests without catalyst and those using catalytically active material shows, for example C1 and WC/Denka, that the catalysts using the respective supports display significant differences despite approximately equally great corrosion of the pure support.

In the case of the pure carbon supports, i.e. the supports which do not comprise a tungsten carbide layer, the results for the pure carbon corrosion without applied catalyst and the decrease in performance with applied catalyst correlate, so that the same degradation mechanism can be assumed.

It can be seen from examples 1 and 2 that the application of the metal carbide layer also exerts an influence on the decrease in performance. The more metal carbide is applied to the support, the lower is the decrease in performance. Furthermore, it can also be seen that the method known, for example, from WO-A 2006/002228 for producing a metal carbide layer does not suffice to improve the corrosion resistance of the support. This can be seen from comparative examples 2 and 3 or 3*.

The figures show transmission electron micrographs which in each case depict a catalyst according to the prior art and a catalyst according to the invention before and after exposure to an electrochemical process.

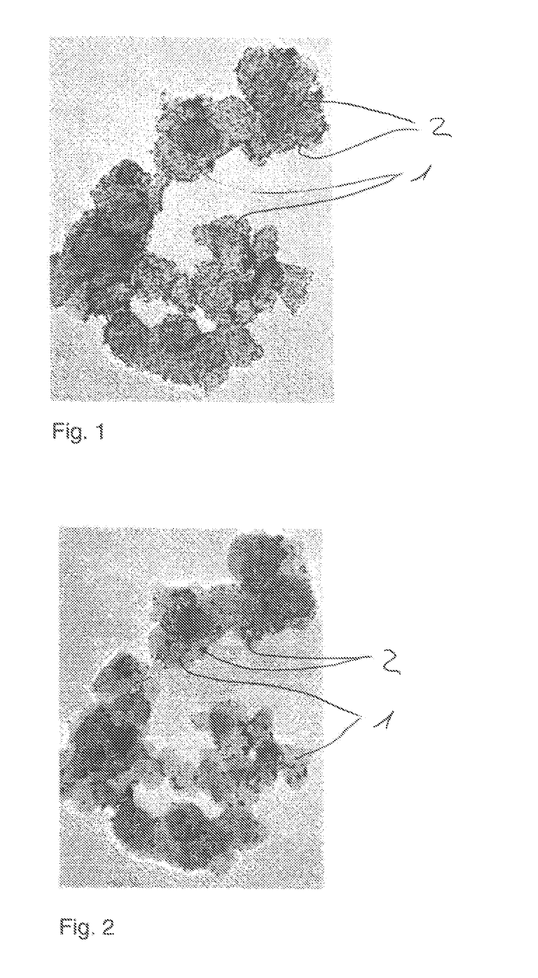

FIG. 1 shows a catalyst as per comparative example 1 before exposure to an electrochemical process,

FIG. 2 shows the catalyst of comparative example 1 after exposure to an electrochemical process,

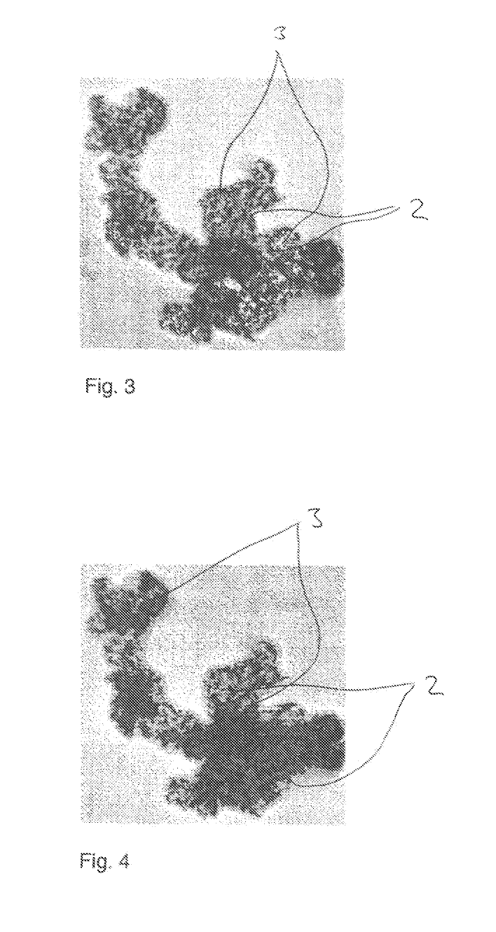

FIG. 3 shows a catalyst as per example 1 before exposure to an electrochemical process,

FIG. 4 shows a catalyst as per example 1 after exposure to an electrochemical process.

In the figures, the uncoated support is denoted by reference numeral 1, the support coated with carbide is denoted by reference numeral 3 and the platinum particles are denoted by reference numeral 2.

Transmission electron micrographs (TEMs) by means of which the same catalyst region was examined before and after exposure to an electrochemical process were taken for the catalysts of example 1 and comparative example 1. The exposure to an electrochemical process was achieved by means of 3600 potential cycles between 0.4 and 1.4 V at an increase of 1 V/s.

It can be seen from the TEMs that the electrocatalysts differ significantly despite the same support stability. On the pure carbon support as per comparative example 1, shown in FIG. 1 before exposure to the electrochemical process and in FIG. 2 after exposure to the electrochemical process, platinum particles 2 become detached from support 1 and are therefore lost to the catalytic reaction. In contrast, it can be seen that in the case of a support 3 having a carbide layer as per example 1, the bonding of the platinum particles 2 to the support is retained. This can be seen in FIGS. 3 and 4, where FIG. 3 depicts the catalyst of example 1 before exposure to the electrochemical process and FIG. 4 depicts the catalyst of example 1 after exposure to the electrochemical process.

As a result of the detachment of the platinum from the carbon support, a significant decrease in performance of the electrocatalysts is to be expected even on very corrosion-resistant carbon supports. To counter this, improved adhesion of the platinum particles to the support is necessary. This is achieved by the modification according to the invention of the carbon surface by means of a carbide layer.

1. A process for producing a catalyst, where the catalyst comprises a catalytically active material and a carbon-comprising support, which comprises the following steps:
(a) impregnation of the carbon-comprising support with a metal salt solution,
(b) heating of the carbon-comprising support impregnated with the metal salt solution to a temperature of at least 1200° C. in an inert atmosphere to form a metal carbide layer,
(c) application of the catalytically active material to the carbon-comprising support provided with the metal carbide layer.

2. The process according to claim 1, wherein the metal salt solution for impregnating the carbon-comprising support is added in a substoichiometric amount.

3. The process according to claim 1, wherein the metal of the metal salt solution is tungsten or molybdenum or a mixture or alloy comprising at least one of these metals.

4. The process according to claim 1, wherein the metal salt solution is a tungstate solution.

5. The process according to claim 1, wherein the heating in step (b) is carried out in an inert atmosphere.

6. The process according to claim 1, wherein the catalytically active metal is a metal of the platinum group or an alloy comprising at least one metal of the platinum group.

7. The process according to claim 6, wherein the alloy comprising the at least one metal of the platinum group is selected from the group consisting of PtNi, PtFe, PtV, PtCr, PtTi, PtCu, PtPd, PtRu, PdNi, PdFe, PdCr, PdTi, PdCu and PdRu.

8. The process according to claim 6, wherein the metal of the platinum group is platinum or palladium.

9. The process according to claim 1, wherein the catalytically active material is applied by reductive precipitation or decomposition and reduction in an H₂/N₂ gas mixture to the carbon-comprising support provided with the metal carbide layer.

10. The process according to claim 1, wherein the carbon-comprising support has a BET surface area of not more than 250 m²/g.

11. A catalyst produced by the process according to claim 1, which comprises a carbon-comprising support and a catalytically active material, with the carbon-comprising support having a metal carbide layer and the catalytically active material having been applied to the carbon-comprising support provided with the metal carbide layer.

12. The catalyst according to claim 11, wherein the carbon-comprising support has a BET surface area of not more than 250 m²/g.

13. The catalyst according to claim 11, wherein the catalytically active material is a metal of the platinum group or an alloy comprising at least one metal of the platinum group.

14. The catalyst according to claim 13, wherein the alloy comprising the at least one metal of the platinum group is selected from the group consisting of PtNi, PtFe, PtV, PtCr, PtTi, PtCu, PtPd, PtRu, PdNi, PdFe, PdCr, PdTi, PdCu and PdRu.

15. The catalyst according to claim 11, wherein the metal of the metal carbide layer comprises tungsten and/or molybdenum.

16. The use of the catalyst according to claim 11 as electrocatalyst in a fuel cell.
